(19) United States
(12) Patent Application Publication
(10) Pub. No.: US 2021/0133937 A1
(43) Pub. Date: May 6, 2021

(54) METHOD AND SYSTEM FOR CREATING, STORING, SHARING, AND DISPLAYING MULTIPLE PERSPECTIVES OF AN IMAGE

(71) Applicants: Hariharan Ganapathy KATHIRVELU, Milpitas, CA (US); Larkin PLAEGER-MCCOLLUM, Milpitas, CA (US)

(72) Inventors: Hariharan Ganapathy KATHIRVELU, Milpitas, CA (US); Larkin PLAEGER-MCCOLLUM, Milpitas, CA (US)

(21) Appl. No.: 16/668,258

(22) Filed: Oct. 30, 2019

(51) Int. Cl. G06T 5/00; G06T 3/40; G06T 3/60

(52) U.S. Cl. CPC G06T 5/009; G06T 3/403; G06T 2210/22; G06T 3/60; G06T 3/4038

(57) ABSTRACT

Disclosed is a computer implemented method for creating, storing and displaying multiple perspectives of an image captured by a computing device of a user. The said method includes providing a plurality of perspective options to the user, and receiving a choice from the user selecting at least one of the plurality of perspective options of the said image. Based on the received choice, the said method includes executing a program for generating the selected perspective of the said image, and providing an option to the user to enhance the said image to result in the enhanced image. The said computer implemented method also includes instructions for enhancing the image, and storing the said enhanced perspective and the said original image in a memory of the said computing device. The enhanced perspective may be allowed to be shared, and displayed over plurality of computing devices.

### FIELD OF THE INVENTION

Embodiments of the present invention are directed to the field of digital imaging, and more specifically, to a method and system for creating, storing, sharing, and displaying a plurality of versions of a single image.

### DESCRIPTION OF THE RELATED ART

In the present era with the proliferation of low cost microprocessors, memory and image capturing electronics, the overall dynamics of digital image capturing have changed drastically. Particularly, digital cameras integrated in smartphones are becoming more and more popular and are being widely used by a large number of consumers.

A digital camera captures an image, and the image is stored electronically in a memory element associated with the camera. The stored image may be further manipulated electronically.

Nowadays, digital cameras are configured to capture multiple images, or exposures, of the “same” object at a rate approaching many tens or hundreds of images per second. Particularly, capturing multiple images raises the possibility of using multiple images to produce a final photograph with significantly improved image quality. However, these digital cameras limit the user to view and share a single version of the image, selected automatically, rather than letting the user select and use any of the multiple variations of the image that were captured.

Many times, while accommodating various needs during capturing, editing and enhancing the digital images, a user may unintentionally discard the useful data associated with the image. Particularly, while zooming into an area of interest such as a person's face (a new perspective), the user zooms in and may crop the image to exclude the outside area such as a mountain in the background (the original perspective) and save the new perspective either as a new file or even in the same file, losing the original perspective.

Moreover, while enhancing the image appearance, such as brightness, saturation, contrast, highlights details, mid tones details, dark details, auto-enhance and other image enhancements, users typically store the newly edited image and end up losing the original information in the saved image. While the image appearance enhancements may improve the display of the new perspective, such as a face, they may worsen the display of the original perspective, such as a mountain in the background. Hence, the valuable original perspective is lost forever, even though both perspectives are valuable.

Furthermore, while viewing an image, if a user zooms in or physically moves the device to change the orientation thereof, they may end up seeing just a small, arbitrary portion of the image on their screen.

The U.S. Pat. No. 7,084,910 focuses on a digital image capture and processing system. The system includes an image sensor configured to capture images from the lens, a memory element and a processor coupled to the lens control element. The memory element has an image capturing software which causes the lens and the image sensor to capture at least two images, where each of the at least two images is captured using a varying parameter and stored as a single file. The two images are combined to form a new image having at least one characteristic different from the corresponding characteristics of the at least two images.

Another U.S. Pat. No. 8,773,709 focuses on an image generation system to generate a high dynamic range image from multiple images acquired in a single short exposure. The image generation system has an image acquisition unit to acquire an image, an image generation unit to generate multiple images with different resolution and brightness from the acquired image, and an image synthesis unit to synthesize the generated images.

Yet another U.S. Pat. No. 6,985,638 focuses on composing an image from multiple partially overlapping images. Both positional movement and perspective transformation are performed using pyramidal data structures. Particularly, the partially overlapping images are composed into a single image while the partially overlapping images efficiently undergo the perspective transformation according to the above determined parameters.

Thus, there remains a need to develop an invention that circumvents the problems of the prior art by introducing a method for storing and sharing multiple related perspectives as one single image, and displaying the appropriate version at the appropriate time, such as determining to display the landscape or portrait version of the image based on the display device orientation. Therefore, there is a need in the industry for a way to exploit the ability of a digital camera to create, capture, store and share multiple perspectives of a single image as one image either in a single image file or linked set of files or packaged set of files.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

In view of the aforesaid needs and shortcomings of the state of the art, the present invention provides a computer implemented method for creating, storing, displaying and sharing an image with multiple perspectives.

Image processing applications where a single image is required to provide multiple perspectives often result in the loss of original valuable information. It will be apparent to a person skilled in the art that the method as disclosed in the present invention is adapted to overcome this problem.

The present invention discloses a computer implemented method for creating, storing, sharing and displaying multiple perspectives of an image captured by a user. The said method includes providing a plurality of perspective selection options to the user and receiving a choice from the user of at least one of the plurality of perspective options of the said image. The method is followed by executing a program for generating the selected perspective of the said image.

The method further includes providing an option to the user to enhance the said image and enhancing the said image. The method is continued with storing the said enhanced perspective and the said original image in a memory of the said computing device.

The method further allows sharing of the said enhanced perspective and the said original image file with a plurality of computing devices related to plurality of other users and displaying the said enhanced perspective and the said original image over the said plurality of computing devices.

In accordance with one embodiment, the said selection of at least one of the plurality of perspective options comprises selection of an orientation format of the said image, wherein the said orientation format is at least one of a portrait mode orientation or a landscape mode orientation.

In accordance with one embodiment of the present invention, the said selection of at least one of the plurality of perspective options comprises selection of at least one new perspective of the said image by selecting a region of interest of the said image.

In accordance to another embodiment, the region of interest is selected by the user by zooming into a region of interest. In one embodiment, the region of interest is selected by the user by drawing a boundary around the region of interest.

In another embodiment, the selection of the region of interest is around a principal focal point of the image. In another embodiment, the selection may be based on an artificial intelligence selection of the region of interest.

In one embodiment of the present invention, zooming into the region of interest by the user is done by identifying a zooming area of the image optimized for one or more screen sizes of one or more computing devices.

Furthermore, the selection of the region of interest around the principal focal point of the image includes cropping the image around the principal focal point of the image.

In one embodiment, the artificial intelligence selection of the region of interest includes optimizing characteristics of the image and selecting the region of interest by user confirmation.

In accordance to yet another embodiment, the image enhancement module includes brightness, saturation, contrast, highlights details, mid tones details, dark details, auto-enhance and other image adjustment tools to enhance the image. In accordance with yet another embodiment, the present invention includes retaining multiple exposure or wider color gamut captures that the camera originally captured as part of a high dynamic range image and enabling the user to select one or more of those individual captures as a new perspective.

The user may zoom or otherwise select one or more regions from one or more of these high dynamic range individual captures to save as a new perspective.

In accordance with one or more embodiments of the present invention, displaying of the image and its multiple perspectives includes displaying an optimal image region and one or more additional perspectives over the computing devices of other users. Particularly, in accordance with one of more embodiments of the present invention, the displaying of the optimal image region is based on one or more hardware components of the computing devices such as the type of the computing device, the orientation of the computing device, the screen dimension of the computing device, the display dimension of the computing device and the area available where the image and one or more perspectives of the image will be displayed.

In accordance with one or more embodiments of the present invention, storing of the single image file can include storing dimension details of the original image and storing dimension details of the multiple variations of the image. Particularly, the details of the multiple variations may include details of all corner coordinates namely, horizontal and vertical coordinates of top-left, top-right, bottom-left and bottom-right coordinates or details of a sequence of coordinates encompassing a shape, or other details specifying the region of one or more new perspectives of the image.

Various embodiments of the present invention display the image and its multiple variations along with the location of the image and the total number of variations. Particularly, the image and its multiple variations are displayed by tapping, clicking or otherwise selecting one of the multiple perspectives. Moreover, the multiple variations of the image may be displayed as a carousel. Subsequently, one or more expanded images are displayed from the multiple variations. Furthermore, the user may view different areas of the image by zooming in or zooming out.

In accordance with one or more embodiments of the present invention, a user creates one or more new variations of the image and adds comments with the new variation and the original image. Particularly, the user can re-share the new variation along with the original image and original variations with other computing devices. Moreover, a user may save and store one or more new variations of the image created by one or more other users.

This together with the other aspects of the present invention along with the various features of novelty that characterize the present disclosure are pointed out with particularity in the claims annexed hereto and form a part of the present invention. For better understanding of the present disclosure, its operating advantages, and the specified objective attained by its uses, reference should be made to the accompanying descriptive matter in which there are illustrated exemplary embodiments of the present invention.

### DESCRIPTION OF THE DRAWING

The advantages and features of the present invention will become better understood with reference to the following detailed description taken in conjunction with the accompanying drawings, in which:

FIG. 1 is a flowchart illustrating a method for creating, storing and displaying an image in accordance with one embodiment of the present invention;

FIGS. 2A-2D include a flowchart illustrating the method for creating, storing and displaying a new perspective of an image having a specific orientation layout in accordance with another embodiment of the present invention;

FIG. 3 is a flowchart illustrating the method for creating, storing and displaying a new perspective of the image having specific regions in different dynamic range in accordance with yet another embodiment of the present invention;

FIGS. 4A-4C illustrates a pictorial representation of the image viewing software application decoding multiple views with indications of multiple perspectives in the image marked by R0, R1, R2 and decoding multiple perspectives and displaying one of the modified perspective (R0) in accordance to one or more embodiments of the present invention;

FIG. 5A is a pictorial representation illustrating the addition of multiple view information to the single file of the image in accordance to one or more embodiments of the present invention;

FIG. 5B is a pictorial representation illustrating display of one or more perspectives of the image in accordance to one or more embodiments of the present invention;

FIGS. 6A-6E depict creation of multiple perspectives in accordance with the computer implemented method of the present invention.

### DESCRIPTION OF THE INVENTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions are not shown or described in detail to avoid unnecessarily obscuring the description of the embodiments of the invention.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

The exemplary embodiments described herein in detail for illustrative purposes are subjected to many variations. However, it should be emphasized that the present invention is not limited. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced items.

The terms “having,” “comprising,” “including,” and variations thereof signify the presence of a component.

References within the specification to “one embodiment,” “an embodiment,” “embodiments,” or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be required for some embodiments but no other embodiments.

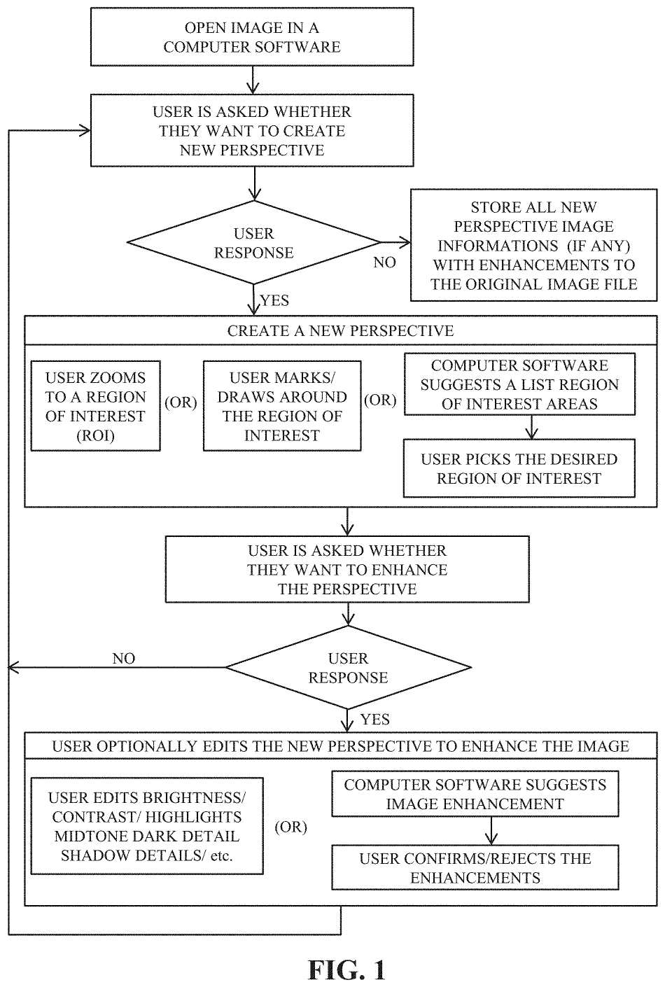

The present invention discloses a computer implemented method for creating, storing and displaying an image having one or more perspectives over a computing device of a user. The present invention will be better understood with reference to FIGS. 1-6.

FIG. 1 is a flowchart illustrating a method for creating, storing and displaying an image with multiple perspectives over a computing device of a user. Particularly, one or more specific regions of the image are created as a new perspective. Moreover, the new perspective is created with or without enhancements.

The method includes selecting one or more perspectives of an image. Particularly, the selection is completed by at least one of a selection means such as selection by a user, by artificial intelligence means, or by a guiding means of the computing device. Moreover, the guiding means guide the user to select multiple perspectives of the image. The method enables the user to accept, reject, and edit one or more said perspectives of the image.

The method starts when the user opens the image in the computing device and a user response determination is made by the said system and method for creating, storing, sharing, and displaying multiple perspectives of an image. The user response determines whether the user wants to create one or more perspectives of the image.

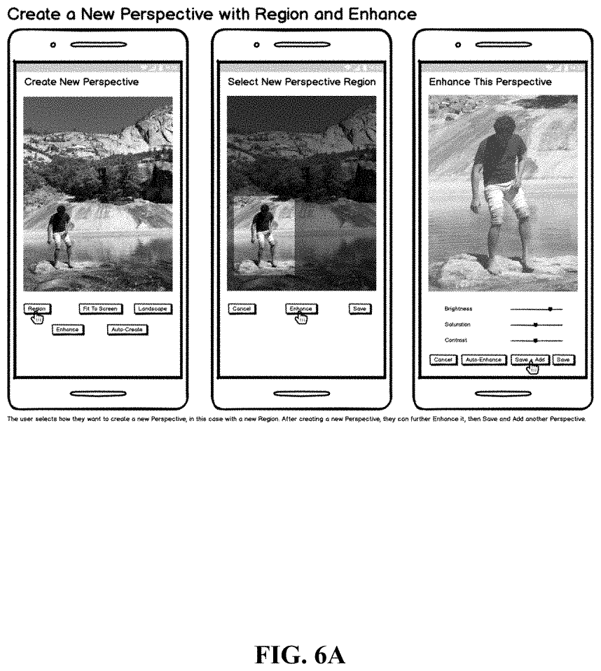

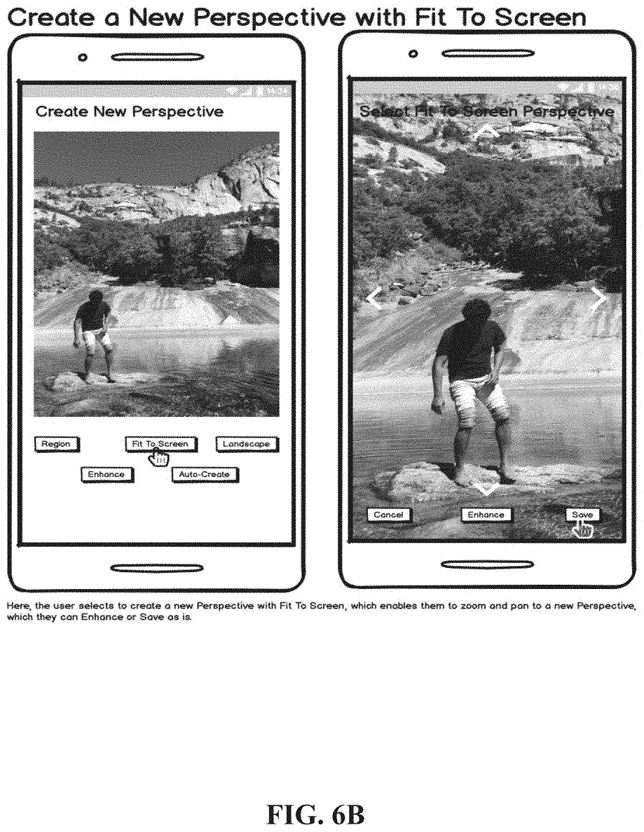

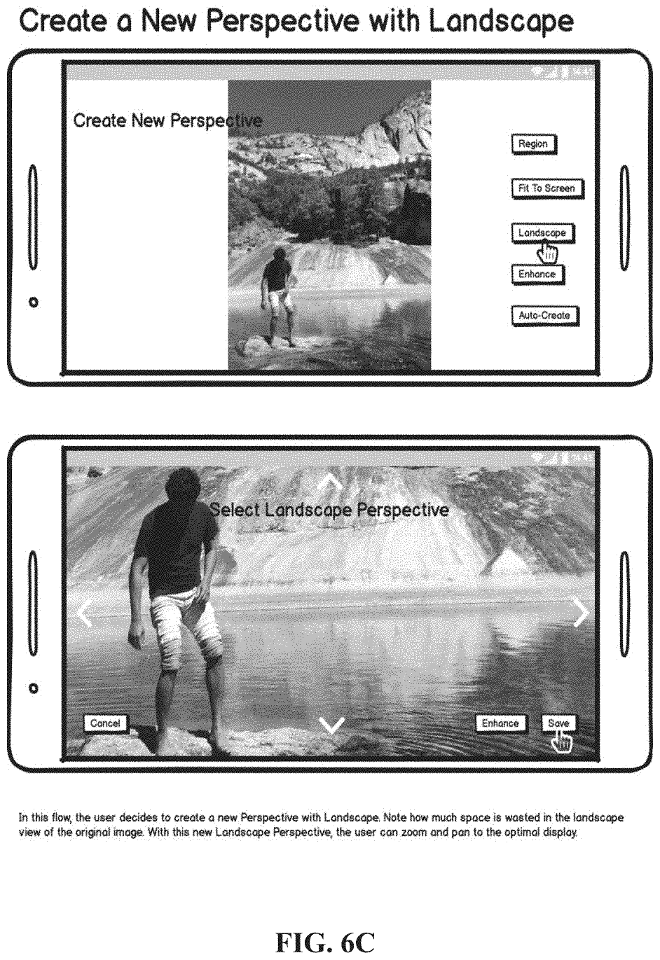

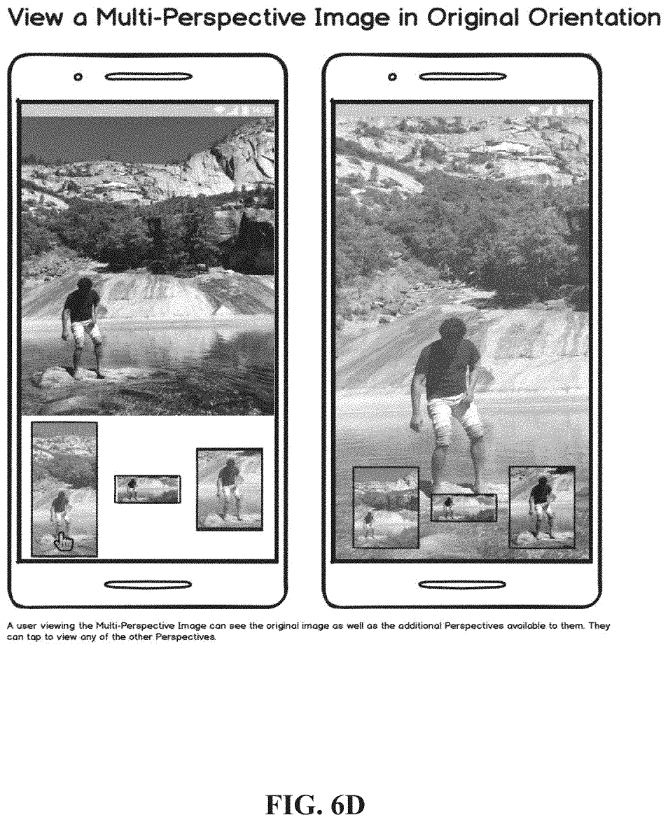

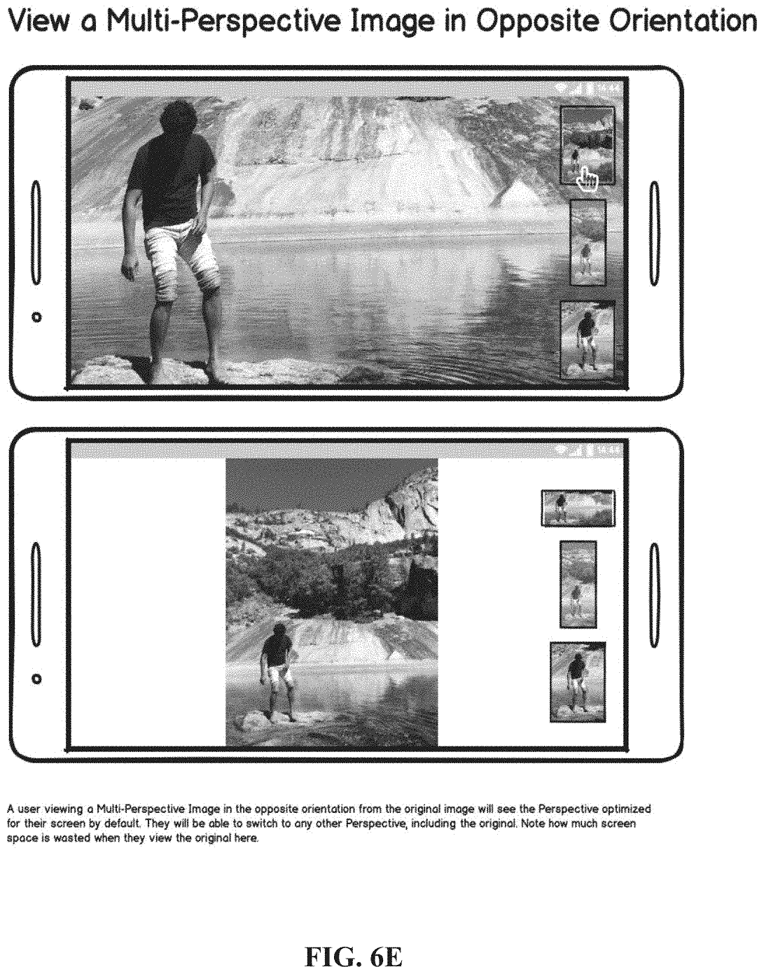

In one embodiment, if the user response is “NO” then all the new perspective image information (if any) with enhancements is stored to the original image file. In another embodiment, if the user response is “YES”, then the user edits the new perspective to enhance the image. The image enhancement module includes brightness, saturation, contrast, highlights details, mid tones details, dark details, auto-enhance and other image enhancement features. Alternatively, the user confirms or rejects the image enhancement suggested by the computer implemented system. This is shown in (FIG. 6A).

In accordance with one or more embodiments of the present invention, as shown in FIG. 6A, the user creates the new perspective of the image by selecting the region of interest, by zooming into a region of interest, or by drawing a boundary around the region of interest.

Particularly, the region of interest may be selected by the user around a principal focal point of the image or by an artificial intelligence selection. Moreover, the zooming of the region of interest may be done by identifying a zooming area of the image optimized for one or more screen sizes of one or more of computing devices.

In addition, the selection of the region of interest around the principal focal point of the image also includes cropping the image around the principal focal point of the image. In one embodiment, artificial intelligence may also be used for selecting the region of interest. In such implementation, such selection may include optimizing contrast and other characteristics of the image and selecting the region of interest by user confirmation.

Further, again a user response determination is made as to whether the user wants to enhance the new perspective of the image. In one embodiment, if the user response is “NO” then all the new perspective image information (if any) with enhancements is stored to the original image file.

In another embodiment of the present invention with reference to FIG. 6A, if the user response is “YES” then the user edits the new perspective to enhance the image. The image enhancement module includes brightness, saturation, contrast, highlights details, mid tones details, dark details, auto-enhance and other image enhancement features. Alternatively, the user confirms or rejects the image enhancement suggested by the computer implemented system.

In an exemplary embodiment of the present invention with reference to FIG. 6B, the user may create a new perspective of the image by selecting an option of “Fit to screen” which enables the user to add a new perspective of the original image specifically optimized for a particular device type and orientation.

Further, as shown in FIG. 6B again a user response determination is made as to whether the user wants to save the new perspective or further enhance the new perspective and then save it.

In accordance with another embodiment of the present invention, users who are invited to view the image may create one or more new perspectives of the image, add comments about the new variation along with the original image, and re-share the new variation and the original image with other computing devices. Further, the user saves and stores one or more new variations of the image created by one or more other users.

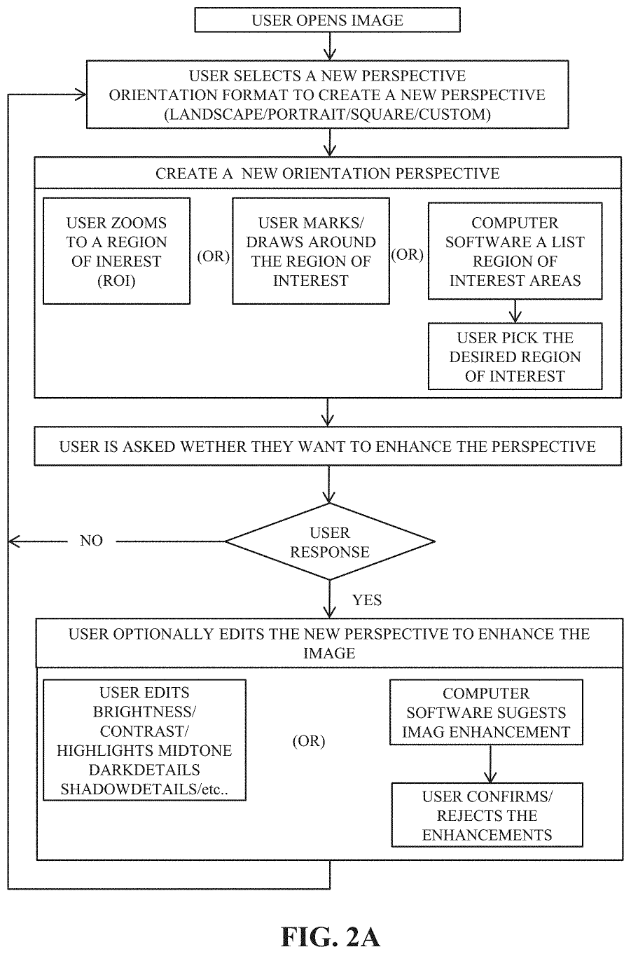

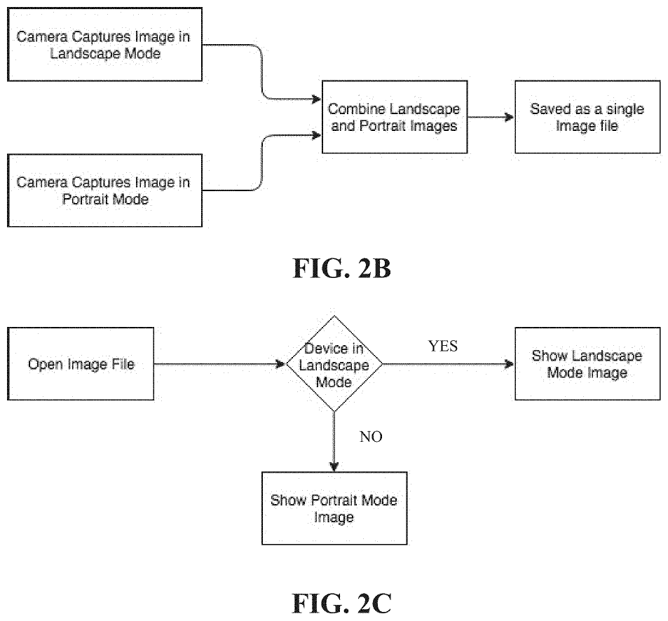

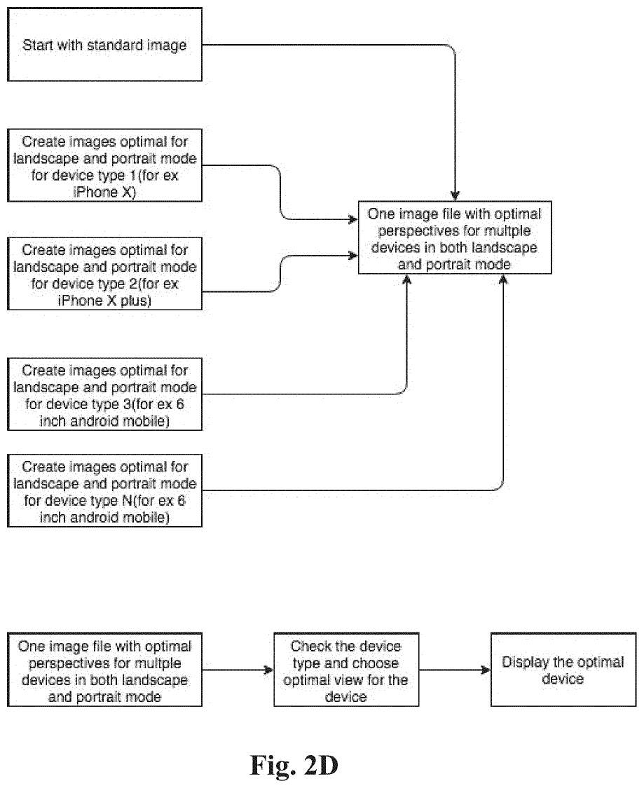

FIGS. 2A-2C are flowcharts illustrating the method for creating, storing and displaying a new perspective of the image having specific orientation layout in accordance to another embodiment of the present invention. The new perspective can be created with or without enhancements.

The method starts when the user opens the image and selects an orientation format to create a new perspective of the image. Particularly, the orientation format is selected from at least one of a portrait mode orientation, a landscape mode orientation, a square or custom format.

A user response determination is made as to whether the user wants to change the orientation. If yes, then the new perspective of the image is created.

In accordance to one or more embodiments of the present invention, user creates the new perspective of the image by selecting a region of interest, by zooming into a region of interest, or by drawing a boundary around the region of interest.

The region of interest may be selected around a principal focal point of the image or by an artificial intelligence selection. Moreover, the zooming of the region of interest may be done by identifying a zooming area of the image optimized for one or more screen sizes of one or more computing devices.

In addition, the selection of the region of interest around the principal focal point of the image also includes cropping the image around the principal focal point of the image. Subsequently, artificial intelligence can also be used for creating the new perspective, which includes optimizing contrast and other viewing characteristics of the image and selecting the region of interest with a user confirmation.

In the exemplary embodiment of the present invention, the user may respond to create the new perspective of the original image by selecting landscape orientation (refer to FIG. 6C), thereby, modifying the original image optimally for landscape orientation by zooming and panning the image to optimal display as shown in FIG. 6C.

In another embodiment, the user may choose to combine the orientations into one single image file. This embodiment is shown in FIG. 2B.

Alternatively, the user might choose to view alternative perspectives in a particular orientation mode. For example, as shown in FIG. 2C the computer implemented method allows the user to open the image and choose a mode of the device, in this case landscape mode. Further, the computer implemented method allows the image to be displayed in portrait or landscape mode depending on the device's original orientation or on user preference.

In yet another embodiment, the computer implemented method allows creation of multiple perspectives based on the device type of the user. Such implementation is shown with reference to FIG. 2D.

As shown in FIG. 2D, the computer implemented method allows creation of multiple perspectives of the same image suited for different computing devices, say iPhone X, iPhone X plus, 6-inch Android devices, and so on and so forth. Such images are optimized for various orientation modes according to various methodologies disclosed with reference to the present invention.

Further, a user response determination is made as to whether the user wants to enhance the new perspective of the image.

In one embodiment, if the user response is “NO”, then all the new perspective image information (if any) with enhancements is saved.

In another embodiment, if the user response is “YES,” then the user edits the new perspective to enhance the image. The image enhancement module includes brightness, saturation, contrast, highlights details, mid tones details, dark details, auto-enhance and other image enhancements features. Alternatively, the user confirms or rejects the image enhancement suggested by the computer implemented system.

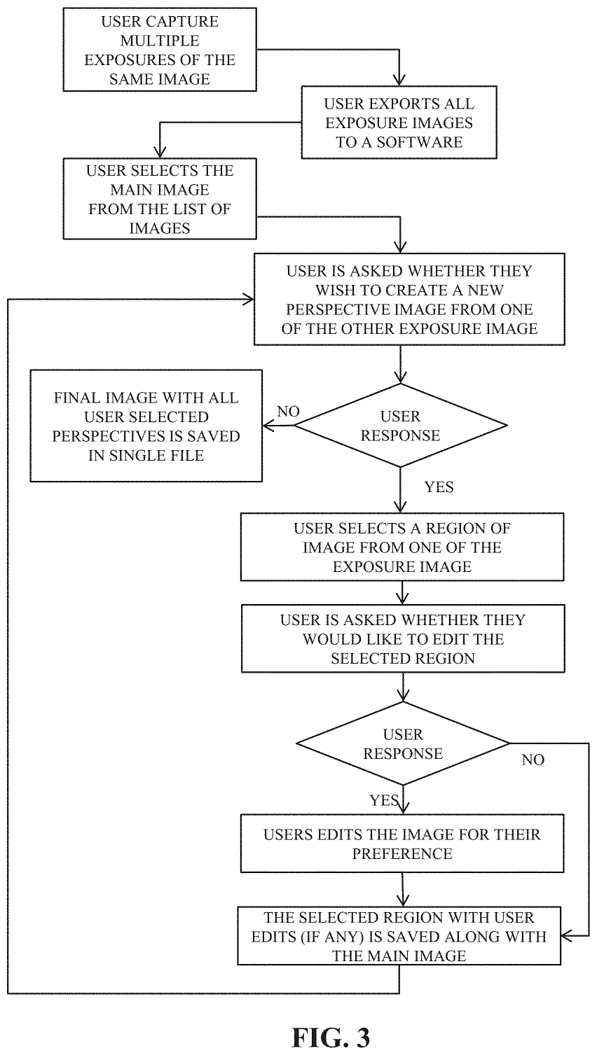

FIG. 3 is a flowchart illustrating a method for creating, storing and displaying a new perspective of the image having specific regions in different dynamic range in accordance with another embodiment of the present invention.

The method includes the user capturing multiple exposures of the image, exporting the exposure image to the computer implemented system and selecting the main image from the list of images. Then a user response determination is made as to whether the user wants to create a new perspective image from one of the exposure image list.

In one embodiment, if the user response is “NO,” then the final image and all the perspectives selected by the user are saved in a single file. Particularly, the multiple perspectives of the image along with the original image are saved and stored in the memory of the computing device.

In another embodiment, if the user response is “YES,” then the user selects one or more new perspectives of the image by selecting a region of interest from one of the exposure image list.

Further, a user response determination is made as to whether the user wants to edit the selected region of the selected image.

In one embodiment, if the user response is “NO”, then the selected perspective is saved with the original image.

In another embodiment, if the user response is “YES” then the user modifies the image using an image enhancement module in accordance to the preference and the selected region with image enhancement is saved with the original image.

Particularly, an original image captured using high dynamic range may be used to create new perspectives. A user can select one of the high dynamic range individual captures, which include multiple exposure captures or wider color gamut captures that the camera originally captured, and save the individual capture as a new perspective. Further, the user may zoom or otherwise select one or more regions from one or more of these high dynamic range individual captures to save as a new perspective.

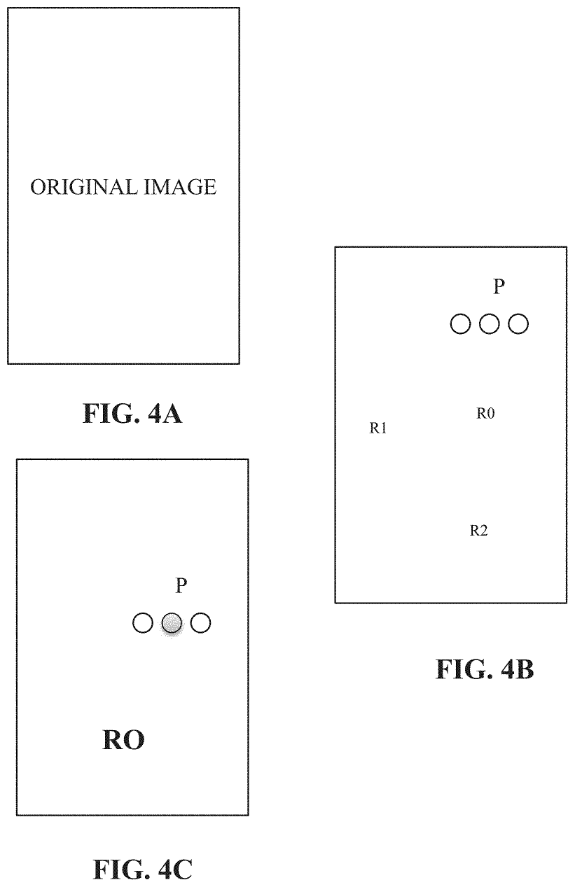

FIG. 4A illustrates a pictorial representation of standard image viewing software decoding and displaying standard image format.

FIG. 4B illustrates a pictorial representation of an image viewing software application supporting the proposed image format decoding multiple views with indication of multiple perspectives in the image marked by R0, R1, R2.

FIG. 4C illustrates a pictorial representation of an image viewing software application supporting the proposed image format and decoding multiple perspectives displaying one of the modified perspective R0.

As shown in FIGS. 4A-4C, the single image file is decoded into the image and its multiple perspectives and displayed over the computing devices of other users. Various embodiments of the present invention also include displaying the image and its multiple variations along with the location of the perspectives and total number of perspectives created. Particularly, the image and its multiple variations are displayed by tapping, clicking or otherwise selecting one of the multiple perspectives. Moreover, one or more variations of the image can be displayed as a carousel. Subsequently, one or more expanded images are displayed from the multiple variations by a viewer. Furthermore, the user can view a different area of the image by zooming in or zooming out the said image.

In an exemplary embodiment of the present invention, as shown in FIG. 6D, the user views the multi-perspective image in original orientation. The user may tap and view any of the additional perspective images which have been created previously by the original user. The said additional perspectives are displayed by tapping, clicking or otherwise selecting one of the multiple perspective images.

In another embodiment of the present invention, the user may view the multi-perspective image in the opposite orientation from the original (refer to FIG. 6E). When the original image is displayed, there is a lot of empty space on the screen. Thereby, the user may prefer to view one of the perspective images which are earlier created by the original user. The user may switch to a different perspective by tapping, clicking or otherwise selecting one of the multiple perspective images.

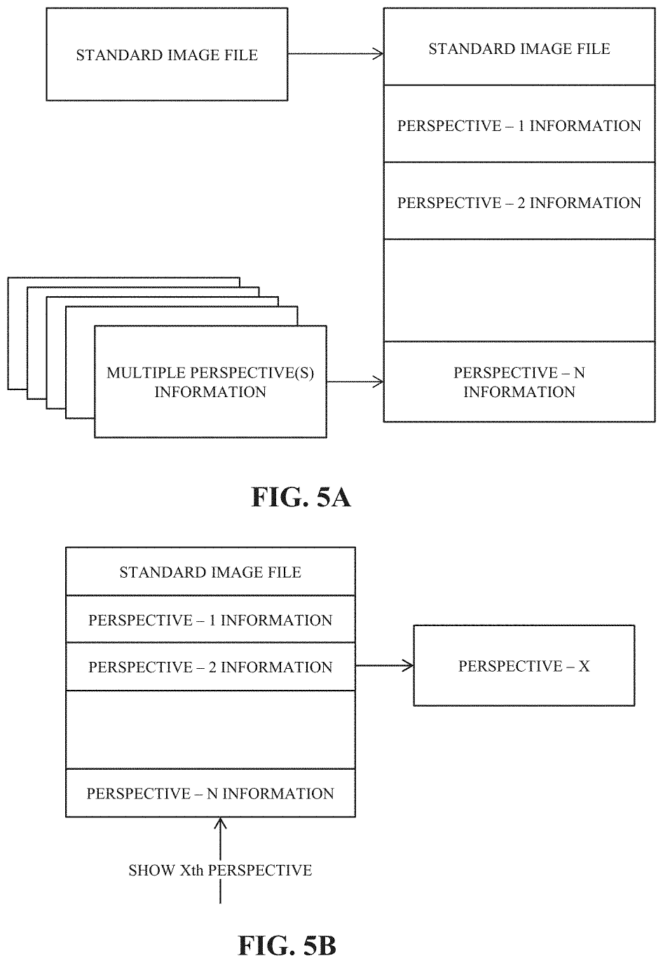

FIG. 5A is a pictorial representation illustrating the addition of multiple view information to the original image in accordance with one or more embodiments of the present invention.

Particularly, as shown in FIG. 5A, the multiple perspectives of the image along with the original image are saved together and stored in the memory of the computing device. The original image and the details of the multiple perspectives may be saved as a single image file, a linked set of files, or a packaged set of files.

In various embodiments, the details of the multiple perspectives are selected from details of all corner coordinates (horizontal and vertical coordinates of top-left, top-right, bottom-left and bottom-right coordinates), or details of a sequence of coordinates encompassing a shape, or other details specifying the region of one or more new perspectives of the image. Furthermore, the single image file is decoded into the final image and its multiple variations and shared with one or more other users via their computing devices.

FIG. 5B is a pictorial representation illustrating displaying of one or more perspectives of the image in accordance with one or more embodiments of the present invention. The image and its multiple perspectives are displayed on an optimal image region over the computing devices of other users.

In various embodiments, the displaying of the optimal image region is based on one or more hardware factors of the computing devices such as the type of the computing device, the orientation of the computing device, the screen dimension of the computing device, the display dimensions of the computing device and the area available where the image and one or more perspectives of the image will be displayed.

Therefore, the present invention discloses a method for storing and sharing multiple related perspectives as one image and displaying the appropriate perspective, such as landscape or portrait versions, automatically according to the display device orientation.

Further, the present invention provides the method by which a digital camera may create, capture, store and share multiple perspectives of a single image as one image either in a single image file or as related image links.

Furthermore, the present invention may overcome challenges which were discussed above.

The foregoing descriptions of specific embodiments of the present invention have been presented for purposes of description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. A computer implemented method for creating, storing and displaying multiple perspectives of an image captured by a computing device of a user, wherein said method comprises:
providing a plurality of perspective options to the user;
receiving a choice from the user of one or more of the plurality of perspective options of the said image;
executing a program for generating the selected perspective of the said image;
providing an option to the user to enhance the said image to result in the enhanced image;
storing the said enhanced perspective and the said original image in a memory of said computing device;
allowing sharing of the said enhanced perspective and the said original image with a plurality of computing devices related to plurality of other users; and
displaying the said enhanced perspective and the said original image over the said plurality of computing devices.

2. The method as claimed in claim 1, wherein the said method comprising allowing the user to create a new perspective option.

3. The method as claimed in claim 1, wherein the said selection of at least one of the plurality of perspective options comprises selection of an orientation format of the said image, wherein the said orientation format may be one of a portrait mode orientation, a landscape mode orientation, a square, or a panorama.

4. The method as claimed in claim 1, wherein the said selection of at least one of the plurality of perspective options comprises generation of at least one new perspective of the said image by selecting a region of interest of the said image.

5. The method as claimed in claim 4, wherein selecting the region of interest comprises,
allowing zooming into a region of interest by the user,
enabling selection of a boundary drawn around the selected region of interest by the user, and
allowing selection of the region of interest around a principal focal point of the image.

6. The method as claimed in claim 5, wherein the selection of the region of interest around the principal focal point of the image comprises cropping the said image around the said principal focal point of the image.

7. The method as claimed in claim 5, wherein the selection of the region of interest is by an artificial intelligence based selection.

8. The method as claimed in claim 5, wherein the zoom in into the region of interest by the user comprises identifying a zooming area of the said image optimized for one or more of a plurality of screen sizes of a plurality of computing devices.

9. The method as claimed in claim 7, wherein the said artificial intelligence selection of the region of interest comprises selecting the region of interest and enhancing the image brightness, saturation, contrast, highlight details, midtone details, dark details, auto-enhance, or other characteristics, with confirmation from the user.

10. The method as claimed in claim 1, wherein the said selection of at least one of the plurality of perspective options of the said image comprises retaining multiple exposure captures or wider color gamut captures that the camera originally captured as part of a high dynamic range image and enabling the user to select one or more of those individual captures as a new perspective.

11. The method as claimed in claim 10, wherein creating the high dynamic range individual capture version of the said image comprises the steps of,
retaining multiple, individual exposure and wider color gamut captures from the original camera images,
enabling the user to select one of those high dynamic range individual captures as a new perspective,
selecting one or more regions from said high dynamic range individual capture from said image, and
adding said one or more regions selected from said high dynamic range individual capture version of said image as a new perspective to the said original image.

12. The method as claimed in claim 1, wherein the said enhancement of the said image comprises selecting an enhanced version of the image by modifying the said image using an image enhancement module.

13. The method as claimed in claim 12, wherein the said image enhancement module includes one or more of brightness, saturation, contrast, highlights details, mid tones details, dark details, auto-enhance and other image enhancements.

14. The method as claimed in claim 1, wherein saving the said plurality of perspectives comprises one of
saving the perspectives along with said original image as a single image file,
saving the said plurality of perspectives along with said original image as a linked set of files,
saving the said plurality of perspectives along with said original image as a packaged set of files.

15. The method as claimed in claim 1, wherein storing the said original image and additional perspectives comprises:
storing details of the said original image, and
storing details of the plurality of perspectives of the said image, wherein details of the plurality of perspectives are selected from at least one of the, details of corner coordinates of at least one new perspective of the said image,
details of a sequence of coordinates encompassing a shape of at least one new perspective of the said image,
additional details specifying the region of at least one new perspective of the said image, and
details specifying image enhancements to new perspectives of the image.

16. The method as claimed in claim 1, wherein displaying the said image and the said plurality of perspectives comprises,
displaying an optimal image region and plurality of perspectives over the said plurality of computing devices related to plurality of other users, wherein displaying the optimal image region is based on at least one of a hardware factor of the said plurality of computing devices, accessibility settings of said devices, or other settings of said devices.

17. The method as claimed in claim 16, wherein the display of the optimal perspective is determined by at least one of,
a hardware factor is selected from type of a computing device where the said image and the said plurality of perspectives is displayed,
an orientation of a computing device where the said image and the said plurality of perspectives are displayed,
a screen dimension of a computing device where the said image and the said plurality of perspectives are displayed,
a display dimension of a computing device where the said image and the said plurality of perspectives are displayed, and
the area available where the said image and the said plurality of perspectives are displayed.

18. The method as claimed in claim 1, wherein said plurality of other users perform steps of:
creating at least one new perspective of said image,
adding a comment to the said at least one new perspective and the said image,
re-sharing the said comment, the said at least one new perspective and the said image with a plurality of other computing devices,
saving the said comment, said at least one new perspective and said image, and
storing the said comment and said at least one new perspective of said image created by said plurality of other users.

19. The method as claimed in claim 1, wherein said selections are completed by the user, by an artificial intelligence means, or by a guiding means of the computing device to guide the user to select a plurality of perspectives of the said image.

20. The method as claimed in claim 1, wherein displaying the said image and said plurality of perspective comprises,
displaying locations of all perspectives of the said image,
displaying the total number of the plurality of perspectives of the said image,
displaying said image and said plurality of perspectives by tapping, clicking or otherwise selecting one of said plurality of perspectives,
displaying said plurality of perspectives of said image as a carousel, and
displaying at least one expanded image from said plurality of perspectives by a viewer.
